(19) United States
(12) Patent Application Publication
(10) Pub. No.: US 2021/0129907 A1
(43) Pub. Date: May 6, 2021

(54) AN AUTOMATIC STEERING DEVICE OF AN AGRICULTURAL MACHINE

(71) Applicants: SHANDONG UNIVERSITY OF TECHNOLOGY, Shandong (CN); NANJING RESEARCH INSTITUTE FOR AGRICULTURAL MECHANIZATION, MINISTRY OF AGRICULTURE, Jiangsu Province (CN)

(72) Inventors: Juan DU, Shandong (CN); Xiang YIN, Shandong (CN); Chengqian JIN, Shandong (CN); Mingqun YU, Shandong (CN); Xianliang WANG, Shandong (CN); Yulong CHEN, Shandong (CN); Youliang NI, Shandong (CN)

(21) Appl. No.: 17/034,341

(22) Filed: Sep. 28, 2020

(30) Foreign Application Priority Data
Oct. 30, 2019 (CN) 201911042885.0

(51) Int. Cl. B62D 15/02; B62D 5/04; B62D 1/16; B62D 1/04; B62D 6/00

(52) U.S. Cl. CPC B62D 15/025; B62D 5/0463; B62D 1/16; H01Q 1/27; B62D 15/021; B62D 6/001; B62D 1/04

(57) ABSTRACT

An automatic steering device of an agricultural machine is provided, which is connected with a steering axle of the agricultural machine and comprises: a data acquisition unit for acquiring data information of the agricultural machine, the data information comprises an actual steering angle value, a travelling position and a travelling direction; a driving unit for providing a rotating torque; a steering unit connected with the driving unit and the steering axle and used for transmitting the rotating torque to the steering axle; and a control unit connected with the data acquisition unit and the driving unit, used for obtaining a steering angle value according to the data information of the agricultural machine, and controlling the driving unit according to the steering angle value. The embodiments have simple structure, can be suitable for the agricultural machine with different steering angle ranges, and have high efficiency and simple operation.

### CROSS-REFERENCE TO RELATED APPLICATIONS

This application claims the priority of Chinese Patent Application No. 201911042885.0 entitled “An Automatic Steering Device of an Agricultural Machine” filed with the Chinese Patent Office on Oct. 30, 2019, which is incorporated herein by reference in its entirety.

### TECHNICAL FIELD

The disclosure relates to a technical field of an automatic control of an agricultural machine, and in particular to an automatic steering device of the agricultural machine.

### BACKGROUND ART

Automatic navigation is an important aspect of intelligence development of a modern agricultural machine, and agricultural machines equipped with automatic navigation can automatically travel along a set route with high accuracy, and can ensure high working quality while reducing labour strength of workers.

However, the automatic steering is one of important support technologies for achieving travel control of the agricultural machine. The automatic steering device rotates a steering wheel to a specified angle according to a steering instruction sent by a navigation system, and adjusts a traveling state of the agricultural machine in real time, so that the agricultural machine travels along the set route. Currently, most domestic and foreign agricultural machines adopt parallel hydraulic circuits, install and control electromagnetic proportional valves to realize an automatic steering function. The method requires a high level of specialized technology for an installing person, has a large number of component parts, are complex in structure, has a time-consuming and laborious for a refit, and has high maintenance cost. Due to differences among structures of the steering system of the agricultural machines, different machines have different steering angle ranges, resulting in complex and time-consuming calibration and calibration processes.

### SUMMARY

The embodiments aim to provide an automatic steering device of an agricultural machine with simple structure, low cost, high efficiency and wide adaptability.

In order to achieve the above object, the disclosure provide an automatic steering device for an agricultural machine, which is connected with a steering axle of the agricultural machine and comprises:

a data acquisition unit for acquiring data information of the agricultural machine; wherein data information of the agricultural machine comprises an actual steering angle value, a travelling position and a travelling direction of the agricultural machine;

a driving unit for providing a rotating torque;

a steering unit connected with the driving unit and the steering axle and used for transmitting the rotating torque to the steering axle; and

a control unit connected with the data acquisition unit and the driving unit and used for obtaining a steering angle value according to data information of the agricultural machine and controlling the driving unit according to the steering angle value.

In some embodiments, the data acquisition unit comprises:

an angle sensor connected with a steering knuckle arm in the steering axle and the control unit and used for acquiring the actual steering angle value of the agricultural machine and sending the actual steering angle value to the control unit; and

an antenna subunit connected with the control unit and used for acquiring the travelling position and the travelling direction of the agricultural machine, the control unit obtains an expected angle value according to the travelling position and the travelling direction, and calculates a difference between the actual steering angle value and the expected angle value to obtain the steering angle value.

In some embodiments, the steering unit comprises:

a steering shaft penetrating through the whole steering unit, extending to the driving unit, connected with the steering axle and used for transmitting the rotating torque to the steering axle;

a torque limiting type coupler connected with the driving unit by the steering shaft and used for limiting the rotating torque so that the actual steering angle value is within a set range; and

a steering column fitted over the steering shaft, connected with the torque limiting type coupler and the steering axle and used for protecting the steering shaft.

In some embodiments, the driving unit comprises:

a gear motor connected with the torque limiting type coupler by the steering shaft, connected with the control unit, and providing the rotating torque to the steering shaft under control of the control unit;

a steering wheel for manually controlling a steering direction; and

a connecting flange connected with the steering wheel and the steering shaft and used for connecting the steering wheel and the steering shaft.

In some embodiments, the antenna subunit comprises:

a positioning antenna connected with the control unit and used for acquiring the travelling position of the agricultural machine in real time and transmitting the travelling position to the control unit; and

a directional antenna which connected with the control unit and used for acquiring the travelling direction of the agricultural machine in real time and transmitting the travelling direction to the control unit.

In some embodiments, the automatic steering device of the agricultural machine further comprises:

a fixed bracket fixedly connected between the gear motor and the steering column and used for stabilizing the driving unit and the steering unit.

In some embodiments, the automatic steering device of the agricultural machine further comprises:

a motor driver connected with the gear motor and the control unit and drives the gear motor to rotate positively and negatively and accelerate and decelerate under the control of the control unit.

In some embodiments, the gear motor is a direct current brushless motor.

According to the specific embodiments provided by the invention, the embodiments have the following technical effects.

The embodiments obtain data information by the data acquisition unit, performs calculation and analysis to obtain the steering angle and controls the drive unit to provide rotating torque through the control unit, and transmits the rotating torque to the steering axle of the agricultural machine by the steering unit. The embodiments are not only simple in structure, but also have high precision, and meanwhile, the embodiments can be adapted to various agricultural machine and are easy to operate.

### BRIEF DESCRIPTION OF THE DRAWINGS

In order to more clearly illustrate the embodiments of the disclosure or the technical solutions in the prior art, drawings required in the embodiments will be briefly described below, it is obvious that the drawings in the following description are only some embodiments of the disclosure, and it is obvious for those skilled in the art that other drawings can be obtained according to the drawings without creative efforts.

FIG. 1 is a view of structures of an automatic steering device of an agricultural machine according to the disclosure in a disassembled condition;

FIG. 2 is a diagram of structures of an automatic steering device of an agricultural machine according to the disclosure in a assemble condition;

FIG. 3 is a schematic view of a work flow of each part of an automatic steering device of an agricultural machine.

List of reference numerals in the figures: 1—a data acquisition unit, 2—a driving unit, 3—a steering unit, 4—a control unit, 6—a fixed bracket, 5—a motor driver, 11—an angle sensor, 12—an antenna subunit, 21—a steering wheel, 22—a connecting flange, 23—a geared motor, 31—a torque limiting type coupler, 32—a steering shaft, 33—a steering column, 121—a positioning antenna and 122—a directional antenna.

### DETAILED DESCRIPTION OF THE EMBODIMENTS

The technical solutions in the embodiments of the disclosure will be clearly and completely described below with reference to the drawings in the embodiments of the disclosure, and it is obvious that the described embodiments are only a part of the embodiments of the disclosure, and not all of the embodiments. All other embodiments, which can be obtained by a person skilled in the art without making any creative effort based on the embodiments in the disclosure, belong to the protection scope of the disclosure.

The embodiments aim to provide an automatic steering device of an agricultural machine, which has advantages of simple structure, easy operation, high efficiency and wide adaptability.

In order to make the aforementioned objects, features and advantages of the embodiments more comprehensible, the embodiments are described in detail with reference to the accompanying drawings and the detailed description below.

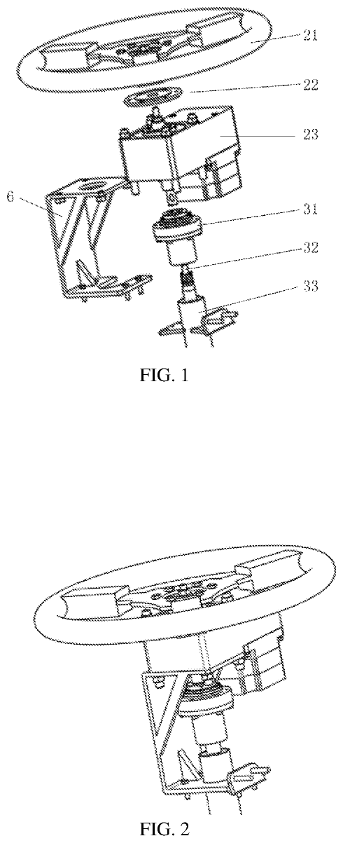

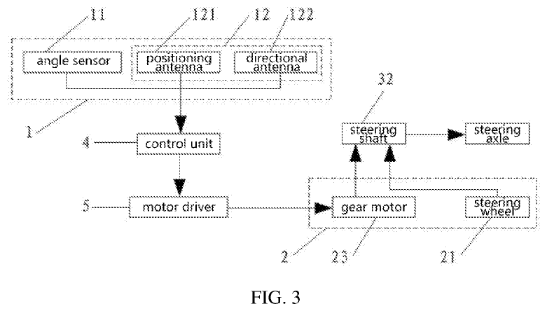

As shown in FIGS. 1 to 3, the automatic steering device of the agricultural machine of the embodiments which is connected with a steering axle of the agricultural machine, comprises: a data acquisition unit 1, a drive unit 2, a steering unit 3 and a control unit 4.

The data acquisition unit 1 is used for acquiring an actual steering angle value, a travelling position and a travelling direction of the agricultural machine. The actual steering angle value, the travelling position and the travelling direction of the agricultural machine are defined as data information of the agricultural machine.

The drive unit 2 is used for providing a rotating torque.

The steering unit 3 is connected with the driving unit 2 and the steering axle, and the steering unit 3 is used for transmitting the rotating torque to the steering axle.

The control unit 4 is connected with the data acquisition unit and the driving unit 2, and the control unit 4 is used for obtaining a steering angle value according to data information of the agricultural machine and controlling the driving unit 2 according to the steering angle value.

As an optional embodiment, the data acquiring unit 1 of the disclosure comprises: an angle sensor 11 and an antenna subunit 12.

The angle sensor 11 is connected with a steering knuckle arm in the steering axle and the control unit 4, and is used for acquiring the actual steering angle value of the agricultural machine and sending the actual steering angle value to the control unit 4.

In this embodiment, the angle sensor 11 and the control unit 4 are connected by a wire, so as to ensure an accuracy of data.

The antenna subunit 12 is connected with the control unit 4, and is used for acquiring the travelling position and the travelling direction. The control unit 4 obtains an expected angle value according to the travelling position and the travelling direction, and calculates a difference between the actual steering angle value and the expected angle value to obtain the steering angle value.

As an optional embodiment, the antenna subunit 12 of the disclosure comprises a positioning antenna 121 and a directional antenna 122.

The positioning antenna 121 is used for acquiring the travelling position in real time and transmitting the travelling position to the control unit 4.

The directional antenna 122 is used for acquiring the travelling direction in real time and transmitting the travelling direction to the control unit 4.

Further, the driving unit 2 is used for providing a rotation torque.

As an optional embodiment, the driving unit 2 of the disclosure comprises a gear motor 23, a steering wheel 21 and a connecting flange 22.

The gear motor 23 is connected with a torque limiting type coupler by a steering shaft 32 and is connected with the control unit 4, and the gear motor 23 provides the rotation torque to the steering shaft 32 under control of the control unit 4.

The steering wheel 21 is connected with the steering shaft 32 by the connecting flange 22 and is used for manually controlling the steering direction, so that an integrated function of manually and automatically operating the agricultural machine is realized, and meanwhile, a quick and effective treatment can be performed under special conditions.

The steering unit 3 is connected with the driving unit 2 and the steering axle and is used for transmitting the rotating torque to the steering axle.

As an optional embodiment, the steering unit 3 according to the disclosure comprises the steering shaft 32, the torque limiting type coupler 31 and a steering column 33.

Wherein the steering shaft 32 penetrates through the steering unit 3, extends to the drive unit 2, and is connected with the steering axle, and the steering shaft 32 is used for transmitting the turning torque to the steering axle.

The torque limiting type coupler 31 is connected with the driving unit 2 by the steering shaft 32, and the torque limiting type coupler 31 is used for limiting the rotating torque so that the actual steering angle value is within a set range.

The steering column 33 is fitted over the steering shaft 32 and is connected with the torque limiting type coupler 31 and the steering axle, and the steering column 33 is used for protecting the steering shaft 32.

The control unit 4 is connected with the data acquisition unit 1 and the gear motor 23, and is used for obtaining a steering angle value according to data information of the agricultural machine and controlling the driving unit 2 according to the steering angle value.

In some embodiments, in order to ensure a safe operation of the device, the automatic steering device of the agricultural machine further comprises a fixed bracket 6.

The fixed bracket 6 is fixedly connected between the gear motor 23 and the steering column 33 and is used for stabilizing the driving unit 2 and the steering unit 3.

Further, for more intelligent control of the gear motor 23, the automatic steering device for agricultural machine further comprises a motor driver 5.

The motor driver 5 is connected with the gear motor 23 and the control unit 4, and the motor driver 5 drives the gear motor 23 to rotate positively and negatively and to accelerate and decelerate, under control of the control unit 4.

In this embodiment, the gear motor 23 is controlled to rotate in a direction of tending, or that tends, to reduce an absolute value of the steering angle value, and a calculation formula for a rotation speed is as follows:

ω=K_{P}Eᵢ+K_{D}(Eᵢ−Eᵢ₋₁)+sign(Eᵢ)*P

In the formula, Eᵢ is a steering angle value of an i-th steering operation, K_{P} and K_{D} are regulating coefficients, and sign(Eᵢ)*P is a minimum value of a control signal when the gear motor starts rotating.

In some embodiments, the gear motor 23 is a direct current brushless motor.

The embodiments have the following beneficial effects:

1) the embodiments can achieve a switch between the manual operation and automatic operation at any time by arranging the gear motor and the steering wheel, and can also take corresponding measures for emergency situations;

2) the embodiments can realize convenient and rapid installation, simple control and excellent performance by adopting the direct current brushless motor as a power source for automatic steering, can ensure a compact structure after installing the brushless motor, so as to facilitate later maintenance, and thus is suitable for a majority of agricultural machines;

3) the control unit disclosed by the embodiments has good quick response characteristic and stability, and the control program can be changed at any time so as to meet the requirements of different steering mechanisms on a response speed and a steering angle range of a system;

4) the automatic steering device of the agricultural machine disclosed by the embodiments, has characteristics of easiness in control, high precision, low cost and the like, can promote development and application of automatic navigation and unmanned driving technology in the field of agricultural machines, and has important significance in reducing labour strength of workers and improving working quality.

In the present specification, the embodiments are described in a progressive manner, each embodiment focuses on differences from other embodiments, and the same and similar parts among the embodiments are referred to each other.

The principles and embodiments of the disclosure have been described herein using specific examples, which are set forth only to help understand the apparatus and core concepts of the disclosure; meanwhile, for a person skilled in the art, according to an idea of the disclosure, there are some changes on specific implementation manners and application fields. In view of the foregoing, the description is not to be taken in a limiting sense.

What is claimed is:

1. An automatic steering device of an agricultural machine, which is connected with a steering axle of the agricultural machine, comprising:
a data acquisition unit configured for acquiring data information of the agricultural machine; wherein the data information of the agricultural machine comprises an actual steering angle value, a travelling position and a travelling direction of the agricultural machine;
a driving unit configured for providing a rotating torque;
a steering unit connected with the driving unit and the steering axle and used for transmitting the rotating torque to the steering axle; and
a control unit connected with the data acquisition unit and the driving unit and used for obtaining a steering angle value according to the data information of the agricultural machine and controlling the driving unit according to the steering angle value.

2. The automatic steering device of the agricultural machine according to claim 1, wherein the data acquisition unit comprises:
an angle sensor connected with a steering knuckle arm in the steering axle and the control unit and used for acquiring the actual steering angle value of the agricultural machine and sending the actual steering angle value to the control unit; and
an antenna subunit connected with the control unit and used for acquiring the travelling position and the travelling direction of the agricultural machine, the control unit obtains an expected angle value according to the travelling position and the travelling direction, and calculates a difference between the actual steering angle value and the expected angle value to obtain the steering angle value.

3. The automatic steering device of the agricultural machine according to claim 1, wherein the steering unit comprises:
a steering shaft penetrating through the whole steering unit, extending to the driving unit, connected with the steering axle and used for transmitting the rotating torque to the steering axle;
a torque limiting type coupler connected with the driving unit by the steering shaft and used for limiting the rotating torque so that the actual steering angle value is within a set range; and
a steering column fitted over the steering shaft, connected with the torque limiting type coupler and the steering axle and used for protecting the steering shaft.

4. The automatic steering device of the agricultural machine according to claim 3, wherein the driving unit comprises:
a gear motor connected with the torque limiting type coupler by the steering shaft, connected with the control unit, and providing the rotating torque to the steering shaft under control of the control unit;
a steering wheel configured for manually controlling a steering direction; and
a connecting flange connected with the steering wheel and the steering shaft and used for connecting the steering wheel and the steering shaft.

5. The automatic steering device of the agricultural machine according to claim 2, wherein the antenna subunit comprises:
a positioning antenna connected with the control unit and used for acquiring the travelling position of the agricultural machine in real time and transmitting the travelling position to the control unit; and
a directional antenna connected with the control unit and used for acquiring the travelling direction of the agricultural machine in real time and transmitting the travelling direction to the control unit.

6. The automatic steering device of the agricultural machine according to claim 4, wherein the automatic steering device of the agricultural machine further comprises:
a fixed bracket fixedly connected between the gear motor and the steering column and used for stabilizing the driving unit and the steering unit.

7. The automatic steering device of the agricultural machine according to claim 4, wherein the automatic steering device of the agricultural machine further comprises:
a motor driver connected with the geared motor and the control unit and drives the gear motor to rotate positively and negatively and to accelerate and decelerate under control of the control unit.

8. The automatic steering device of the agricultural machine according to claim 4, wherein the gear motor is a direct current brushless motor.
